(19) United States
(12) Patent Application Publication
(10) Pub. No.: US 2014/0295312 A1
(43) Pub. Date: Oct. 2, 2014

(54) SYSTEMS AND METHODS FOR CONFIGURING A FUEL CELL HAVING LOWER COOLANT PATH ISOLATION RESISTANCE

(71) Applicant: GM GLOBAL TECHNOLOGY OPERATIONS LLC, DETROIT, MI (US)

(72) Inventor: ROBERT S. FOLEY, ROCHESTER, NY (US)

(73) Assignee: GM GLOBAL TECHNOLOGY OPERATIONS LLC, DETROIT, MI (US)

(21) Appl. No.: 13/854,821

(22) Filed: Apr. 1, 2013

(51) Int. Cl. H01M 8/04; H01M 8/24

(52) U.S. Cl. CPC H01M 8/04029; H01M 8/249
USPC 429/465; 429/471; 429/535

(57) ABSTRACT

System and methods relating to a configuration for a fuel cell system having lower coolant path isolation resistances are disclosed. In certain embodiments, the fuel cell system may include a first fuel cell substack comprising a first plurality of cells. The fuel cell system may further include a second fuel cell substack comprising a second plurality of cells. The first and second fuel cell substacks may share at least one terminal and/or share a common wet end. A coolant system may be coupled to the first fuel cell substack and the second fuel cell substack and be configured to remove heat generated by the first fuel cell substack and the second fuel cell stack during operation of the fuel cell system using a coolant.

### TECHNICAL FIELD

This disclosure relates to fuel cell systems. More specifically, but not exclusively, this disclosure relates to a configuration for a fuel cell system having lower coolant path isolation resistances.

### BACKGROUND

Passenger vehicles may include fuel cell (“FC”) systems to power certain features of a vehicle's electrical and drivetrain systems. For example, a FC system may be utilized in a vehicle to power electric drivetrain components of the vehicle directly (e.g., electric drive motors and the like) and/or via an intermediate battery system. A FC system may include a single cell or, alternatively, may include multiple cells arranged in a stack configuration.

In certain embodiments, a cooling system may be associated with a FC system. The cooling system may be configured to remove heat from the FC system generated during its operation using a circulated coolant. In conventional FC systems, high resistance coolants and/or long coolant paths may help prevent leakage current from flowing between a FC stack and the FC chassis and/or the vehicle chassis. Such high resistance coolants and/or long coolant paths, however, may limit types of coolant that may be used in an FC system and/or introduce difficulties in the manufacture and packaging of the FC system.

### SUMMARY

Systems and methods are presented relating to a configuration for a FC system having lower coolant path isolation resistances. A FC system consistent with certain embodiments disclosed herein may include a first FC substack comprising a first plurality of cells. The FC system may further include a second FC substack comprising a second plurality of cells. The first and second FC substacks may share at least one terminal and/or share a common wet end. A coolant system may be coupled to the first FC substack and the second FC substack and be configured to remove heat generated by the first FC substack and the second FC substack during operation of the fuel cell system using a coolant. In certain embodiments, utilizing first and second substacks in the aforementioned manner may allow for coolant paths to have lower isolation resistances while still meeting leakage and/or body current and/or isolation resistance safety requirements.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates an example of a FC system in a vehicle consistent with embodiments disclosed herein.

FIG. 2 illustrates a conceptual circuit diagram of a conventional FC stack configuration consistent with embodiments disclosed herein.

FIG. 3 illustrates a conceptual circuit diagram of an exemplary FC stack configuration consistent with embodiments disclosed herein.

FIG. 4 illustrates an exemplary FC stack configuration consistent with embodiments disclosed herein.

FIG. 5 illustrates a flow chart of an exemplary method for arranging a FC system consistent with embodiments disclosed herein.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure will be best understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

Embodiments of the systems and methods disclosed herein provide for a FC system configuration having lower coolant path isolation resistances than conventional FC systems. Certain embodiments may be utilized in conjunction with a proton exchange membrane (“PEM”) FC system, although other types or FC systems may also be utilized. In a PEM-type FC, hydrogen may be supplied to an anode of the FC, and oxygen may be supplied as an oxidant to a cathode of the FC. A PEM FC may include a membrane electrode assembly (“MEA”) including a proton transmission non-electrical conductive solid polymer electrolyte membrane having an anode catalyst on one of its faces and a cathode catalyst on the opposite face. The MEA may be disposed between a pair of electrically conductive elements serving as current collectors for the anode and cathode and including one/or more channels and/or openings for distributing the gaseous reactants over the surfaces of the respective anode and cathode catalysts.

A FC system may include a single cell or, alternatively, may include multiple cells arranged in a stack configuration. For example, in certain embodiments, multiple cells may be arranged in series to form a FC stack. In a FC stack, a plurality of cells may be stacked together in electrical series and be separated by a gas impermeable, electrically conductive bipolar plate. The bipolar plate may perform a variety of functions and be configured in a variety of ways. In certain embodiments, the bipolar plate may define one or more internal cooling passages and/or channels including one or more heat exchange surfaces through which a coolant may flow to remove heat from the FC stack generated during its operation.

A variety of coolants may be utilized in the FC system. For example, in certain embodiments, water, antifreeze, and/or any combination thereof may be utilized as FC system coolants. In further embodiments, an FC coolant may comprise methanol, glycol, ethylene glycol, propylene glycol, glycerol, Dex-cool®, and/or any other combination thereof. In certain FC systems, a high resistance and/or low conductivity coolant may be utilized to help prevent leakage and/or body current from flowing between a FC stack and the FC chassis and/or vehicle chassis. Excess leakage and/or body current may be associated with a variety of FC system issues including, for example, short circuiting, corrosion, and electrolyzing the coolant. Such issues may reduce FC system efficiency.

In certain embodiments, an isolation resistance of the system from leakage currents may be influenced, at least in part, by the resistance and/or conductivity of the coolant and/or the geometry of the coolant passages (i.e., the coolant paths). In conventional FC systems, high resistance coolants and/or long coolant paths defined by the coolant passages may be used to meet certain isolation resistance and/or leakage and/or body current safety requirements. Such high resistance coolants and/or long coolant paths, however, may limit the types of coolant that may be used in an FC system and/or introduce difficulties in the manufacture and packaging of the FC system.

Consistent with embodiments disclosed herein, a FC system may be configured to allow for more flexibility in selecting coolant types and/or easier packaging due to shorter coolant paths. In certain embodiments, a first portion of a FC stack (e.g., a first substack) and a second portion of an FC stack (e.g., a second substack) may share a common terminal at an intermediate electrical point (e.g., a common wet end). For example, a first substack may include a negative terminal that is shared with a positive terminal of the second substack. The first substack may operate at a first portion of the full voltage of the complete FC stack and the second substack may operate at a second portion of the full voltage of the complete FC stack. In some embodiments, the intermediate electrical point may be an electrical center point of the FC stack. In such embodiments, the first substack and the second substack of the FC stack may each operate at half of the full voltage of the complete FC stack.

In some embodiments, configuring the FC stack to include a first portion and a second portion in the aforementioned manner may allow for coolant paths to have lower isolation resistances while still meeting leakage and/or body current and/or isolation resistance safety requirements. For example, in a FC stack where the first substack and the second substack of each operate at half of the full voltage of the complete FC stack, the coolant paths of the FC stack may have half of the isolation resistance of a conventional FC stack. Lower isolation resistance requirements may allow for higher permissible coolant conductivity and a broader spectrum of suitable coolant types that may be used on connection with the FC system. Moreover, shorter coolant paths associated with the first and second substack configuration may allow for easier manufacture and packaging of the complete FC system.

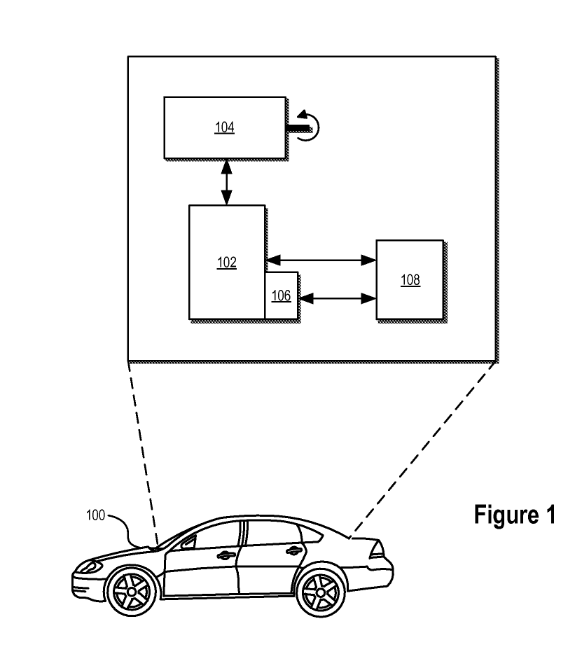

FIG. 1 illustrates an example of a FC system 102 in a vehicle 100 consistent with embodiments disclosed herein. The vehicle 100 may be a motor vehicle, a marine vehicle, an aircraft, and/or any other type of vehicle, and may include any suitable type of drivetrain for incorporating the systems and methods disclosed herein. As illustrated, vehicle 100 may include a FC system 102 configured to provide electrical power to certain components of the vehicle 100. For example, FC system 102 may be configured to provide power to electric drivetrain components 104 of the vehicle 100. The FC system 102 may include a single cell or multiple cells arranged in a stack configuration, and may include certain FC system elements and/or features described above.

As illustrated, the FC system 102 may be configured to directly provide power to electric drivetrain components 104. In certain embodiments, the FC system 102 may be configured to provide power to electric drivetrain components 104 via an intermediate battery system (not shown). In further embodiments, the FC system 102 may be configured to provide power to one or more other battery systems (not shown) including low voltage battery systems (e.g., lead-acid 12V automotive batteries) that supply electric energy to a variety of vehicle 100 systems including, for example, vehicle starter systems (e.g., a starter motor), lighting systems, audio systems, and/or the like.

A cooling system 106 may be coupled to the FC system 102 and be configured to remove heat from the FC system 102 (e.g., during operation of the FC system) through circulation of one or more coolants. The cooling system 106 may comprise any suitable number of pumps, valves, coolant circulation paths (e.g., piping), coolant reservoirs, heat exchangers (e.g., liquid/liquid, liquid/air, liquid/AC unit, and the like), cooling system electronics (e.g., feedback mechanisms, temperature sensors, thermostats, coolant flow sensors, pump and heat exchanger control electronics, and the like), and/or any other cooling system component and/or system in any suitable configuration for circulating the coolant to various components and systems included in the FC system 102. In certain embodiments, the cooling system 106 may comprise and/or be associated with one or more bipolar plates included in the FC system 102 that may define one or more internal cooling passages including one or more heat exchange surfaces through which a coolant may flow to remove heat from the FC system 102.

The FC system 102 and/or the cooling system 106 may be communicatively coupled with an associated a FC control system 108. The FC control system 108 may be configured to monitor and control certain operations of the FC system 102, the cooling system 106, and/or other associated systems. For example, the FC control 108 system may be configured to monitor and control charging and/or discharging operations of the FC system 102. Further, the FC control system 108 may be configured to monitor and/or control cooling operations of the cooling system 106. In further embodiments, an internal vehicle computer system (not shown) and/or any other suitable computer system may be configured to monitor and control certain operations of the FC system 102 and/or the cooling system 106.

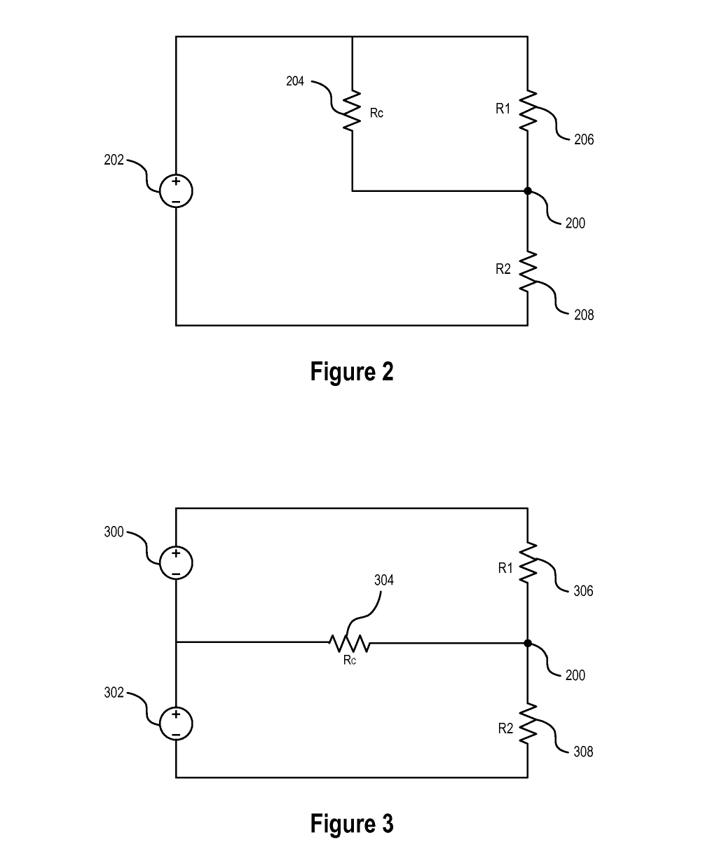

FIG. 2 illustrates a conceptual circuit diagram of a conventional FC stack 202 configuration consistent with embodiments disclosed herein. A positive terminal isolation resistance between a positive terminal of the FC stack 202 and a grounded chassis 200 (e.g., a vehicle chassis and/or a FC chassis) may be represented by resistor R1 206. A negative terminal isolation resistance between a negative terminal of the FC stack 202 and the grounded chassis 200 may be represented by resistor R2 208. An isolation resistance associated with a coolant system may be represented by resistor Rc 204.

As discussed above, a FC system may have an associated leakage and/or body current and/or isolation resistance safety requirement. Such a requirement may be expressed in terms of a leakage and/or body current threshold. For example, a exemplary leakage and/or body current threshold for a FC system may be 10 mA. In an exemplary configuration of the illustrated conceptual circuit diagram where the FC stack has a voltage of 300 V, a resistor R1 206 resistance of 1 MΩ, a resistor R2 208 resistance of 1 MΩ, and a coolant system isolation resistance of 32 kΩ, the leakage and/or body current (“I_{body}”) of the FC system may be approximated according to Equation 1:

$${I}_{body} = \frac{150 V}{16 k Ω ,} + \frac{300 V}{1 M Ω} 9.675 mA . \qquad Equation 1$$

Accordingly, in the aforementioned exemplary FC system configuration, the leakage and/or body current meets a current threshold safety requirement of 10 mA. To meet such a requirement, however, a 32 kΩ coolant system isolation resistance is utilized, which may be associated with higher resistance and/or lower conductivity coolants and/or longer coolant paths.

FIG. 3 illustrates a conceptual circuit diagram of an exemplary FC stack configuration consistent with embodiments disclosed herein. The FC stack may include a first substack 300 and a second substack 302 configured to share a common end (e.g., a common wet end). For example, as illustrated, a negative terminal of the first substack 300 and a positive terminal of the second substack 302 may be electrically coupled and/or shared. An isolation resistance between a positive terminal of the first substack 300 and a grounded chassis 200 (e.g., a vehicle chassis and/or a FC chassis) may be represented by resistor R1 306. An isolation resistance between a negative terminal of the second substack 302 and the grounded chassis 200 may be represented by resistor R2 308. An isolation resistance associated with a FC coolant system of the FC stack may be represented by Rc 304.

In an exemplary configuration of the illustrated conceptual circuit diagram wherein each substack has a voltage of 150 V, a resistor R1 206 resistance of 1 MΩ, a resistor R2 208 resistance of 1 MΩ, and a coolant system isolation resistance of 16 kΩ, the leakage and/or body current (“I_{body}”) of the FC system may be approximated according to Equation 2:

$${I}_{body} = \frac{150 V}{16 k Ω ,} + \frac{300 V}{1 M Ω} 9.675 mA . \qquad Equation 2$$

Accordingly, in the exemplary FC system configuration consistent with embodiments disclosed herein, to meet a current threshold safety requirement of 10 mA, a 16 kΩ coolant system isolation resistance may be utilized (e.g., half the coolant system isolation resistance of the FC system illustrated in FIG. 2). Utilizing a smaller coolant isolation resistance to meet current threshold safety requirements may allow for a larger variety of coolant-types to be used in connection with the FC system (e.g., coolants having lower resistances and/or higher conductivity). Moreover, shorter coolant paths may be utilized in the design of the FC system, which may allow for easier manufacture and packaging of the FC system.

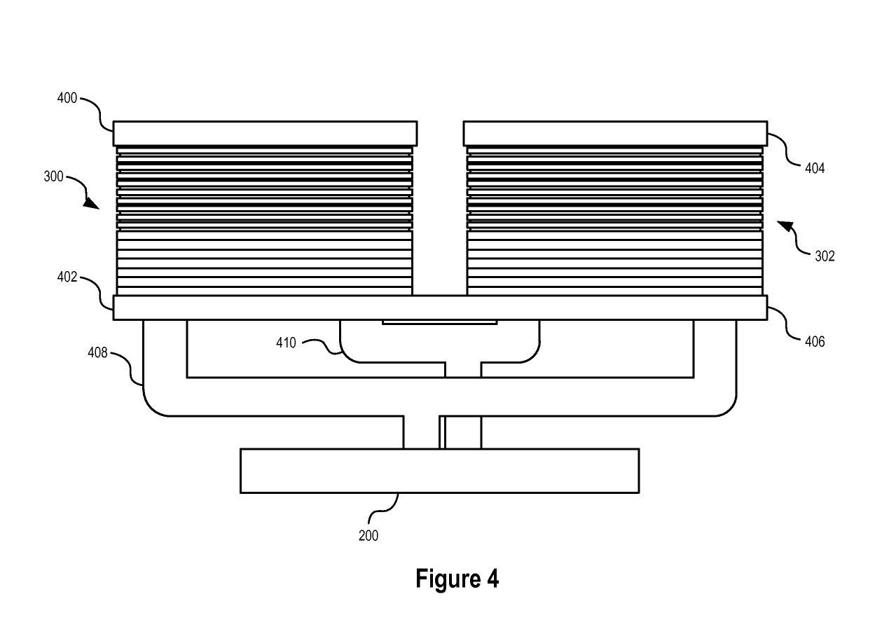

FIG. 4 illustrates an exemplary FC stack configuration consistent with embodiments disclosed herein. The FC stack may include a first substack 300 and a second substack 302 that may share a common terminal at an intermediate electric point which, in certain embodiments, may be a common wet end of the substacks 300, 302. For example, a first substack 300 may include a positive terminal 400 and a negative terminal 402. A second substack 302 may include a negative terminal 404 and a positive terminal 406 shared with the negative terminal 402 of the first substack 300. One or more coolant paths 408, 410 may provide a path of a certain conductivity associated with a coolant isolation resistance between the substacks 300, 302 and a grounded chassis 200 (e.g., a FC and/or vehicle chassis).

As discussed above, configuring the FC stack to include first and second substacks 300, 302 in the aforementioned manner may allow for coolant paths 408, 410 to have lower isolation resistances while still meeting leakage and/or body current and/or isolation resistance safety requirements than conventional designs. For example, in a FC stack where the first substack 300 and the second substack 302 each operate at half of the full voltage of the complete FC stack, the coolant paths 408, 410 of the FC stack may exhibit half of the isolation resistance of a conventional FC stack. Lower isolation resistance requirements may allow for higher permissible coolant conductivity and a broader spectrum of suitable coolant types that may be used on connection with the FC system. Moreover, shorter coolant paths 408, 410 may allow for easier manufacture and packaging of the complete FC system.

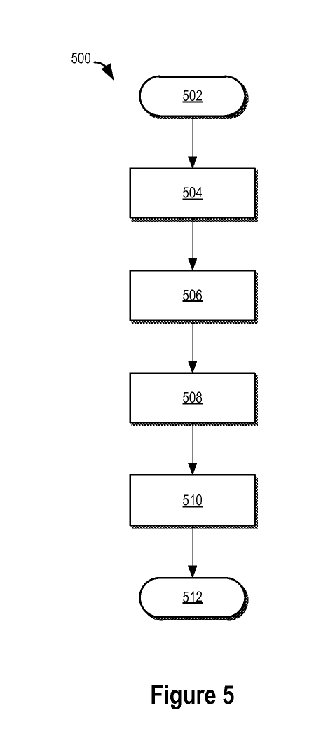

FIG. 5 illustrates a flow chart of an exemplary method 500 for arranging a FC system consistent with embodiments disclosed herein. At 502, the method may be initiated. At 504, a first FC substack comprising a first plurality of cells may be arranged in a FC system. At 506, a second FC substack comprising a second plurality of cells may be arranged in the FC system. At 508, first terminal of the first FC substack may be electrically to a second terminal of a second FC substack. In certain embodiments, this may result the first FC substack and the second FC substack sharing a common wet end. At 510, a coolant system may be coupled to the first FC substack and the second FC substack configured to remove heat generated by the first FC substack and the second FC stack during operation of the FC system by circulating a coolant. At 512, the method 500 may terminate.

Although the foregoing has been described in some detail for purposes of clarity, it will be apparent that certain changes and modifications may be made without departing from the principles thereof. For example, in certain embodiments, the systems and methods disclosed herein may be utilized in FC systems not included in a vehicle (e.g., as in back-up power sources or the like). It is noted that there are many alternative ways of implementing both the processes and systems described herein. Accordingly, the present embodiments are to be considered illustrative and not restrictive, and the invention is not to be limited to the details given herein, but may be modified within the scope and equivalents of the appended claims.

The foregoing specification has been described with reference to various embodiments. However, one of ordinary skill in the art will appreciate that various modifications and changes can be made without departing from the scope of the present disclosure. For example, various operational steps, as well as components for carrying out operational steps, may be implemented in alternate ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

As used herein, the terms “comprises” and “includes,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the following claims.

1. A fuel cell system comprising
a first fuel cell substack comprising a first plurality of cells;
a second fuel cell substack comprising a second plurality of cells, the second fuel cell substack sharing at least one terminal with the first fuel cell substack; and
a coolant system coupled to the first fuel cell substack and the second fuel cell substack configured to remove heat generated by the first fuel cell substack and the second fuel cell stack during operation of the fuel cell system using a coolant.

2. The fuel cell system of claim 1, wherein the first fuel cell substack and the second fuel cell substack share a common wet end.

3. The fuel cell system of claim 1, wherein the coolant system is configured to circulate the coolant.

4. The fuel cell system of claim 1, wherein cells of the first plurality of cells and the cells of second plurality of cells are each separated by a bipolar plate.

5. The fuel cell system of claim 4, wherein the bipolar plate comprises a channel through which the coolant system is configured to circulate the coolant.

6. The fuel cell system of claim 5, wherein the bipolar plate comprises a heat exchange surface proximate to the channel.

7. The fuel cell system of claim 1, wherein the first fuel cell substack and the second fuel cell substack are each configured to operate at half of a full voltage of the fuel cell system.

8. The fuel cell system of claim 1, wherein the first fuel cell substack and the second fuel cell substack each comprise hydrogen fuel cell stacks.

9. The fuel cell system of claim 1, wherein the fuel cell system comprises a proton exchange membrane fuel cell system.

10. The fuel cell system of claim 1, wherein the coolant comprises water.

11. The fuel cell system of claim 1, wherein the coolant comprises an antifreeze solution.

12. The fuel cell system of claim 1, wherein the coolant comprises a glycol solution.

13. The fuel cell system of claim 1, wherein the coolant system defines an electrical path between the first fuel cell substack and the second fuel cell substack and a grounded chassis via the coolant.

14. The fuel cell system of claim 13, wherein the grounded chassis comprises a fuel cell system chassis.

15. The fuel cell system of claim 13, wherein the grounded chassis comprises a vehicle chassis.

16. The fuel cell system of claim 1, wherein the fuel cell system is configured to provide electrical power to a vehicle drivetrain system.

17. The fuel cell system of claim 1, wherein a negative terminal of the first fuel cell substack is coupled with a positive terminal of the second fuel cell substack

18. A method comprising:
arranging a first fuel cell substack comprising a first plurality of cells in a fuel cell system;
arranging a second fuel cell substack comprising a second plurality of cells in the fuel cell system;
coupling a first terminal of the first fuel cell substack to a second terminal of a second fuel cell substack; and
coupling a coolant system to the first fuel cell substack and the second fuel cell substack configured to remove heat generated by the first fuel cell substack and the second fuel cell stack during operation of the fuel cell system using a coolant.
